(19) United States
(12) Patent Application Publication
(10) Pub. No.: US 2007/0016649 A1
(43) Pub. Date: Jan. 18, 2007

(54) Group communication assistance system

(76) Inventor: Kenya Nishiki, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/485,369

(22) Filed: Jul. 13, 2006

(30) Foreign Application Priority Data
Jul. 15, 2005 (JP) 2005-206316

(51) Int. Cl. G06F 15/16

(52) U.S. Cl. 709/206

(57) ABSTRACT

It becomes more difficult to correctly display presence by restricting an operation burden of users when the number of communication counter-parts (bodies) increases. An assistance system includes an event notice setting functional unit for conducting prior setting for notifying a change of presence of a buddy to a presence server; a dynamic buddy list management functional unit for acquiring presence information of a buddy list to which the buddy belongs by taking the event notified from the presence server as an opportunity, and displaying the presence information on a display screen in a form suitable for the buddy list; and an interface control functional unit for controlling a user interface.

### INCORPORATION BY REFERENCE

The present application claims priority from Japanese application JP2005-206316 filed on Jul. 15, 2005, the content of which is hereby incorporated by reference into this application.

### BACKGROUND OF THE INVENTION

This invention relates to a technology for assisting smooth group communication in an office. More particularly, the invention relates to a technology for controlling a user interface on an event-driven basis.

As IP telephony has been wide spread in recent years, it has become necessary for the composition of an information processing system of a company to provide business transactions and customer services while making direct dialogs such as “preliminary meeting” and “consultation” by utilizing IP telephones and TV conferences.

When Mr. A is in conference or temporarily leaves his seat, for example, Mr. B has not been able in the past to known the timing at which Mr. A returns to his desk, or needs a time to check communication means when Mr. A is out of the office. Therefore, a presence management system that materializes communication by grasping on the real-time basis the condition of counter-parts has now gained a wider application. Here, the term “presence” means people, matters, conditions and attributes of information. In the case of people, for example, the term represents work conditions (on-line/off-line, busy/rest) and utilizable communication means. When the matter is a document, the term represents the conditions such as waiting for approval/under circulation/discard, processing priority such as normal/urgent and security such as restricted/strictly secret.

In the field of this presence, a technology is known (JP-A-2003-196243) that stores in advance an action rule for changing the mode of display of condition information of a counter-part (hereinafter called “buddy”) with whom a certain user wants to communicate and an application condition representing the condition under which the action rule is applied, and automatically displays a list registering bodies (hereinafter called “buddy list”) corresponding to the condition of the user by the rule that selects “for work” as a display object in the buddy list for the period of 9 to 17 o'clock, for example.

### SUMMARY OF THE INVENTION

Recently, the number of bodies and the presence information to be confirmed have increased with the increase of moving frequency of users and a technology for correctly exploiting the presence while suppressing an operation burden of users has become necessary. The prior art technology described above filters the presence information to be displayed on user terminals but such filtering is limited only when it has been clarified beforehand which work or business should be done at which time. In other words, when a user executes a plurality of works or businesses in parallel, it is extremely difficult to define a filtering rule corresponding to such works or businesses and to display the presence information of the buddy list associated with the works or business that are to be carried out in practice. Furthermore, the load reduction of the presence server is not achieved because filtering is carried out on the side of the user terminal.

It is therefore an object of the invention to provide a group communication assistance system capable of correctly grasping the condition of bodies even when the presence of the bodies changes in complicated ways.

One of the preferred embodiments of the invention for solving the problem described above is as follows.

An assistance system connected to a presence server, includes an event notice setting functional unit for conducting prior setting for notifying a change of the presence of a buddy to the presence server; a dynamic buddy list management functional unit for acquiring presence information of a buddy list to which the buddy belongs by taking the event notified from the presence server as an opportunity, and displaying the presence information on a display screen in a form suitable for the buddy list; and an interface control functional unit for controlling a user interface.

Other objects, features and advantages of the invention will become apparent from the following description of the embodiments of the invention taken in conjunction with the accompanying drawings.

### BRIEF DESCRITPION OF THE DRAWINGS

FIG. 1 shows a system composition;

FIG. 2 shows a hardware composition of the system;

FIG. 3 shows functional units of a group communication assistance system;

FIG. 4 shows a sequence of office communication utilizing presence;

FIG. 5 shows a user terminal screen for automatic notice setting of an event;

FIGS. 6A, 6B show user terminal screens for displaying an event;

FIG. 7 shows a user terminal screen for displaying presence information in a floor view form;

FIG. 8 shows a user terminal screen for displaying presence information in a location view form;

FIGS. 9A, 9B and 9C show user terminal screens for displaying in detail presence information in a popup form;

FIG. 10 is a flowchart of an initialization/event notice setting functional unit;

FIG. 11 is a flowchart of a dynamic buddy list management functional unit;

FIG. 12 shows an example of buddy list information; and

FIG. 13 shows an example of event notice setting information.

### DESCRIPTION OF THE EMBODIMENTS

Preferred embodiments of the invention will be hereinafter explained.

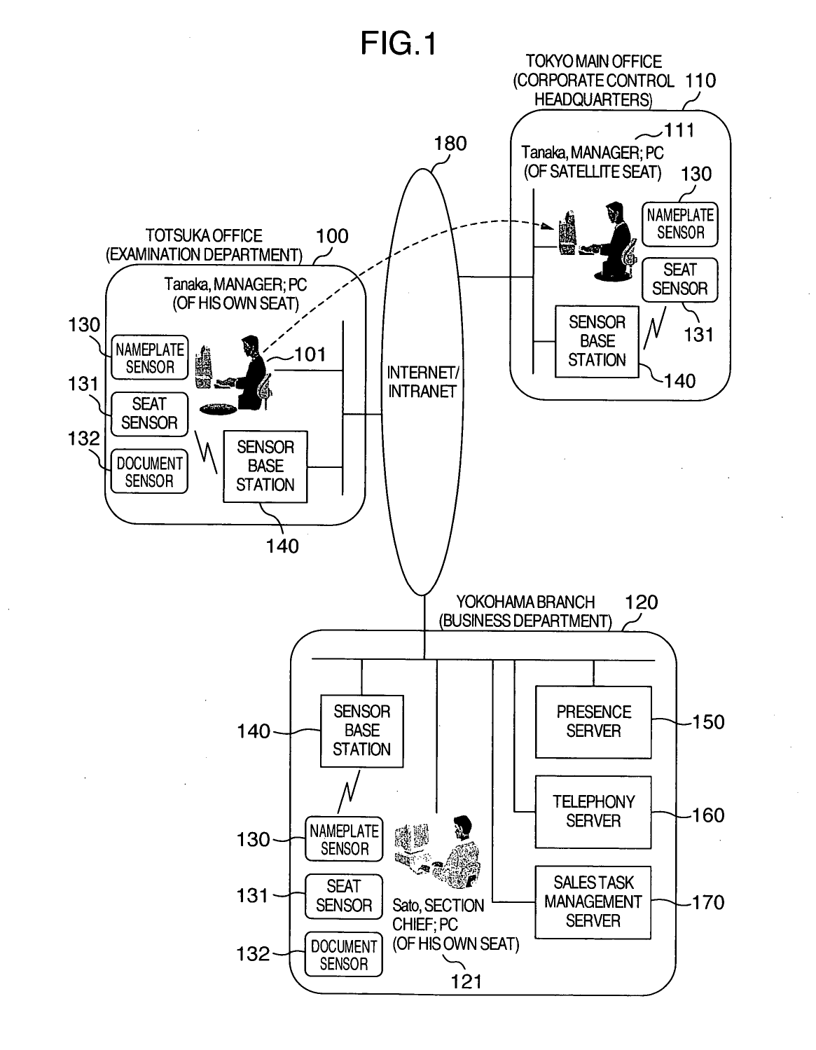

FIG. 1 shows a system composition. Totsuka Office 100 in which an examination department is located, Tokyo Main Office 110 in which a corporate control headquarters is located and Yokohama Branch 120 as a business department are connected to one another through the Internet or Intranet.

Mr. Tanaka, manager of the examination department, has his own desk 101 in Totsuka Office and a satellite desk 111 in the Tokyo main office. Mr. Sato, section chief of the business department, has his own desk 121 in Yokohama Branch 120. Users belonging to each office (Totsuka Office, Tokyo Main Office and Yokohama Branch) use a PC having a group communication assistance system (hereinafter called “assistance system”) 300. Incidentally, though only the desks of the manager and the section chief are shown in FIG. 1, ordinary user desks exist in practice and a plurality of PCs is connected to other appliances (presence server 150, etc) in the same way as the PC of the manager.

A nameplate sensor 130, a seat sensor 131, a document sensor 132, a sensor base station 140, a presence server 150, a telephony server 160 and a sales task management server 170 are installed in each office.

The presence server 150 unitarily manages the user's presence information and reports presence updating to terminals registering perusal of buddy lists. The telephony server 160 is a server that executes call control of IP telephone. The sales task management server 170 manages the progress of sales tasks and business information such as proceedings.

The buddy such as the manager wears the nameplate sensor 130 when coming to the office and the seat sensor 131 for sensing taking of a seat is installed to the seat. A tray equipped with the document sensor 132 for sensing the existence/absence of documents is put on the desk. A wireless tag is put to each circulation document and the location of the document can be grasped by reading the tag by the sensor. The data acquired by each sensor is gathered to the sensor base station 140 and is further notified to the presence server 150 and the sales task management server 170. The condition of the telephone terminals managed by the telephony server 160 is notified to the presence server 150, too.

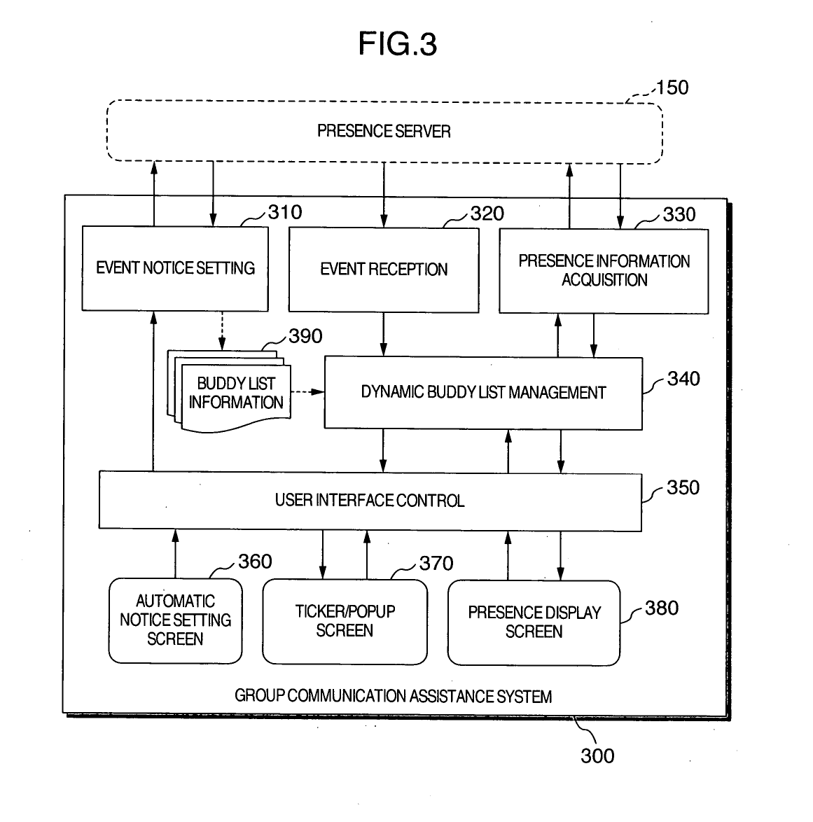

FIG. 3 shows functional units of the group communication assistance system 300.

The assistance system 300 includes an initialization/event notice setting functional unit 310 for communicating with the presence server 150 such as HTTP and acquiring the buddy list or executing event notice setting, an event reception functional unit 320 communicating with the presence server 150 such as HTTP and exchanging the presence information, a dynamic buddy list management functional unit 340 for acquiring/displaying the presence information on the basis of the event notice, a user interface control functional unit 350 for controlling user screens such as an automatic notice setting screen 360, a ticker/popup screen 370, a presence display screen 380, and so forth, and buddy list information 390 for holding the buddy list and the notice setting information.

Incidentally, the function of the assistance system is materialized on the user terminal at the seat of the ordinary user belonging to 101, 111 and 121 in FIG. 1 and to each office. This function may be materialized by executing the program describing the function of the assistance system 300 by a CPU. The function may further be materialized by accomplishing the assistance system 300 by hardware connected to the user terminals.

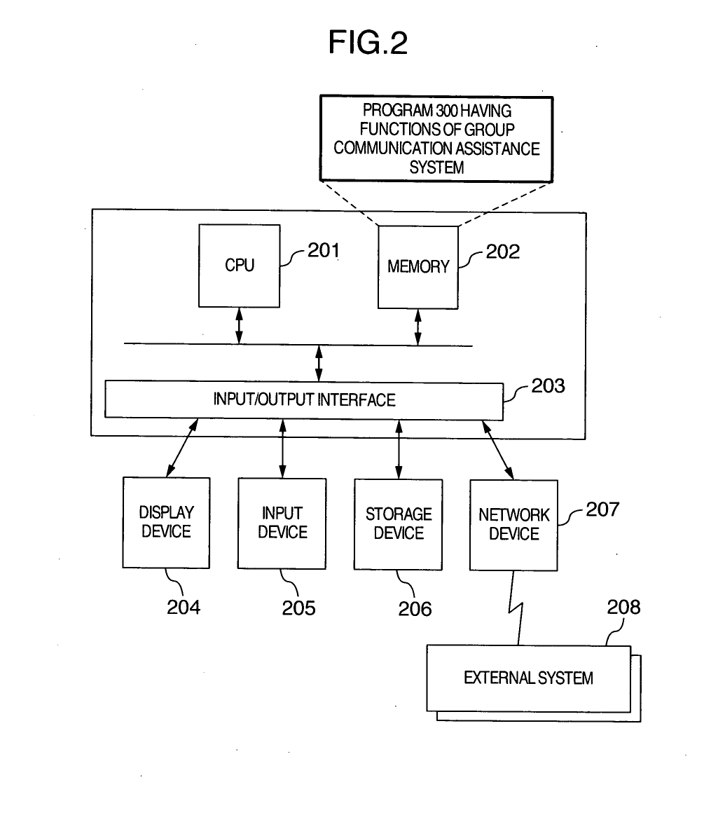

FIG. 2 shows a hardware composition view of a user terminal. The functional units of the assistance system 300 shown in FIG. 3 can be constituted on a computer having hardware such as a CPU 201, a memory 202, an input/output interface 203, a display device 204, an input device 205, a storage device 206 and a network device 207 that are mounted to the computer. In this case, a program 300 describing each function is read into the memory 202 and is activated as a process during the execution. The assistance system 300 is connected to the presence server 150, the telephony server 160 and the sales task management server 170 through the network device 207. When the assistance system 300 is constituted by hardware as described above, the assistance system 300 may be connected through the network device 207.

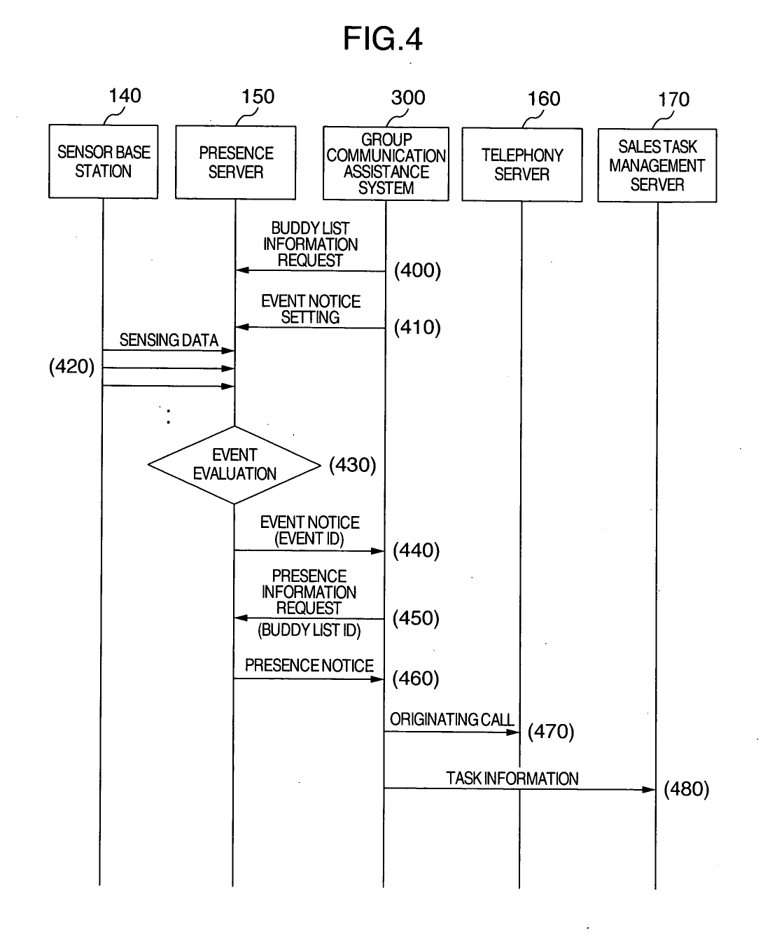

FIG. 4 is a sequence diagram of the office communication utilizing the presence. Incidentally, the explanation will be hereby given on the assumption that the assistance device 300 is by itself the subject of action.

First of all, the assistance system 300 transmits an acquisition request message of the buddy list information to the presence server 150 (400) and executes event notice setting (410). The presence server 150 then receives sensing data from the sensor base station (420) and evaluates whether or not the sensing data is in conformity with the event condition (430). When the sensing data is in conformity, an event (event ID) is reported to the terminal (440).

Next, the assistance system 300 transmits the notice request of the presence information from the terminal to the presence server 150 with the buddy list ID on the basis of the instruction from the user (450). The presence server 150 registers the buddy list ID and reports the presence of the buddy list (460). Finally, the assistance system 300 displays the presence information and dispatches a call to the telephony server 160 (470) or transmits the task information to the sales task management server 170 (480) on the basis of the instruction from the user. Incidentally, this process is executed in each office 100, 100, 120 shown in FIG. 1.

The detail of the user interface provided by the assistance system 300 will be hereinafter explained.

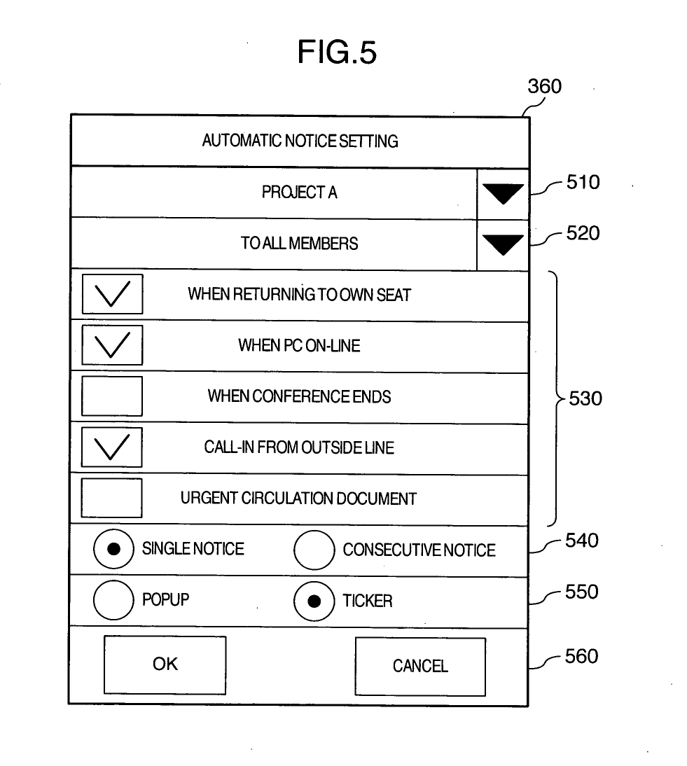

FIG. 5 shows a user terminal screen for automatic notice setting of the event.

On the automatic notice setting screen 360, it is possible to select a buddy list name (“project A”, “Totsuka Office”, “Examination Department”, etc) 510, the buddy name (“all members”, “Manager Tanaka”, etc) 520, items of presence for reporting updating (“upon return to seat”, “PC on-line”, “upon completion of meeting”, “call-in from outside line”, “urgent circulation document”, etc) 530, notice frequency (either “single time notice” or “consecutive notice”) 540 and display type (either “popup” or “ticker”) 550. Setting is executed by pushing down an “OK” button after the selection is made. Setting is not executed when a “cancel” button is pushed (560).

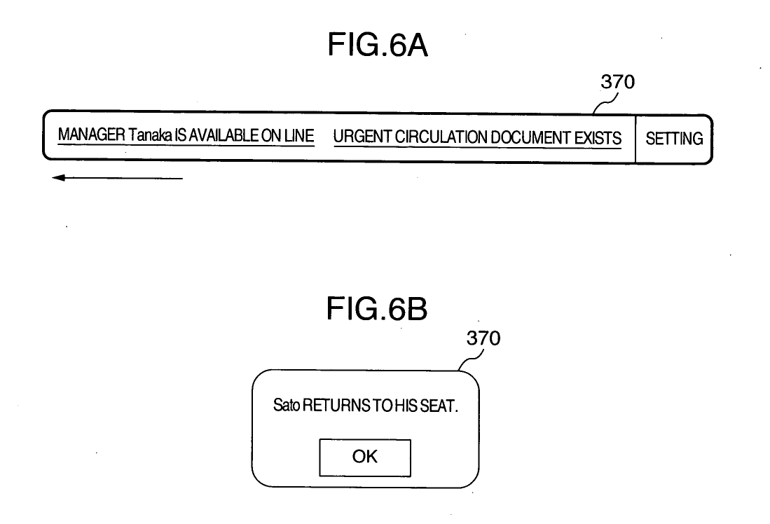

FIGS. 6A, 6B show user terminal screens for displaying the event.

Reference numeral 370 in FIG. 6A displays the event reported by the ticker. For example, texts reading “Manager Tanaka is available on-line”, “Urgent document is circulated”, etc, are displayed in scroll. The automatic notice setting screen described above is activated when the “set” button is pushed. When a specific display item is clicked by a mouse, the presence display screen can be activated, too.

Reference numeral 370 in FIG. 6B displays the event reported by popup. For example, a text reading “Section Chief Sato returns to his desk” is displayed. The display is turned off when the “OK” button is pushed. The presence display screen can be activated, too, after the popup is turned off.

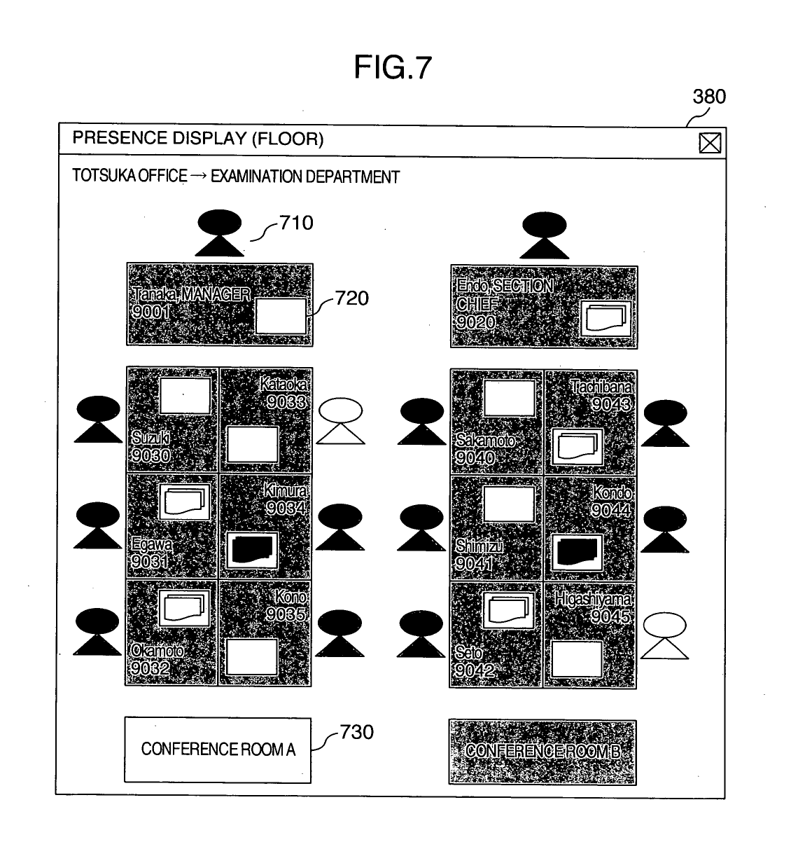

FIG. 7 shows a user terminal screen for displaying the presence information in the floor view form.

The presence display (floor) screen 380 displays users belonging to a specific post at positions of seat layout. In the floor layout of the examination department of Totsuka Office, for example, a user icon 710 displays the user presence by the shape of the icon and its color. The user presence can be represented by three forms, that is, attendance and present at seat, attendance and not present at seat and going-out, for example. A tray icon 720 represents document presence of each user by the shape of the ion and its color. Circulation documents can be displayed by three forms, that is, no circulation document, ordinary circulation document and urgent circulation document, for example. A conference room icon 730 represents conference room presence by the shape of the ion and its color. For example, the conference room icon 730 represents the conference presence in two forms, that is, in-use and not in-use.

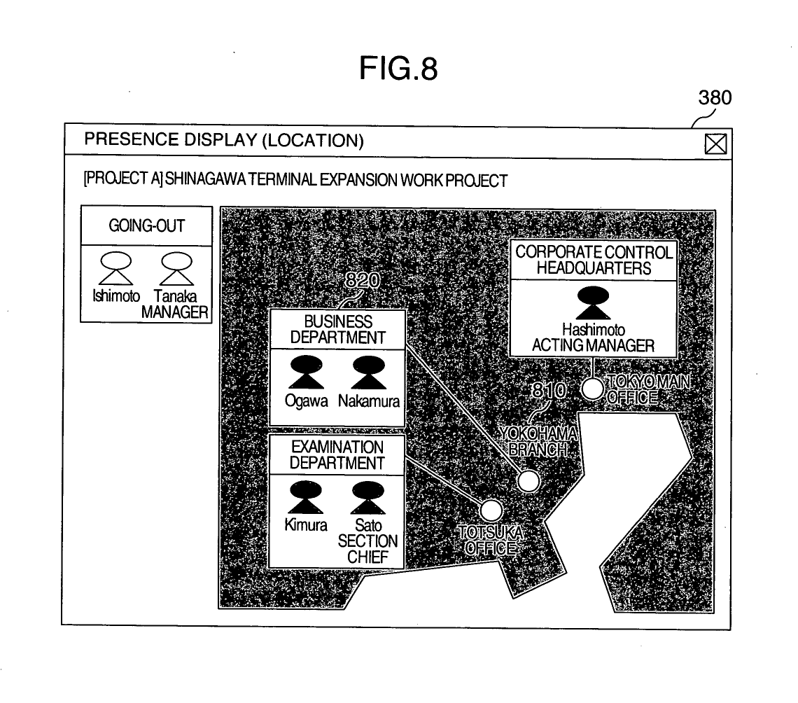

FIG. 8 shows a user terminal screen displaying the presence information by a location view form.

The presence display (location) screen 380 displays those users who belong to a specific project at locations where they exit at present. As for a Shinagawa Terminal expansion work task of a project A, for example, three key sites of Tokyo Main Office, Yokohama Branch and Totsuka Office are displayed by the icons (810) and the users existing at each site are further displayed by the icons (820). Those users whose where-about is unknown are displayed in a “going-out” window.

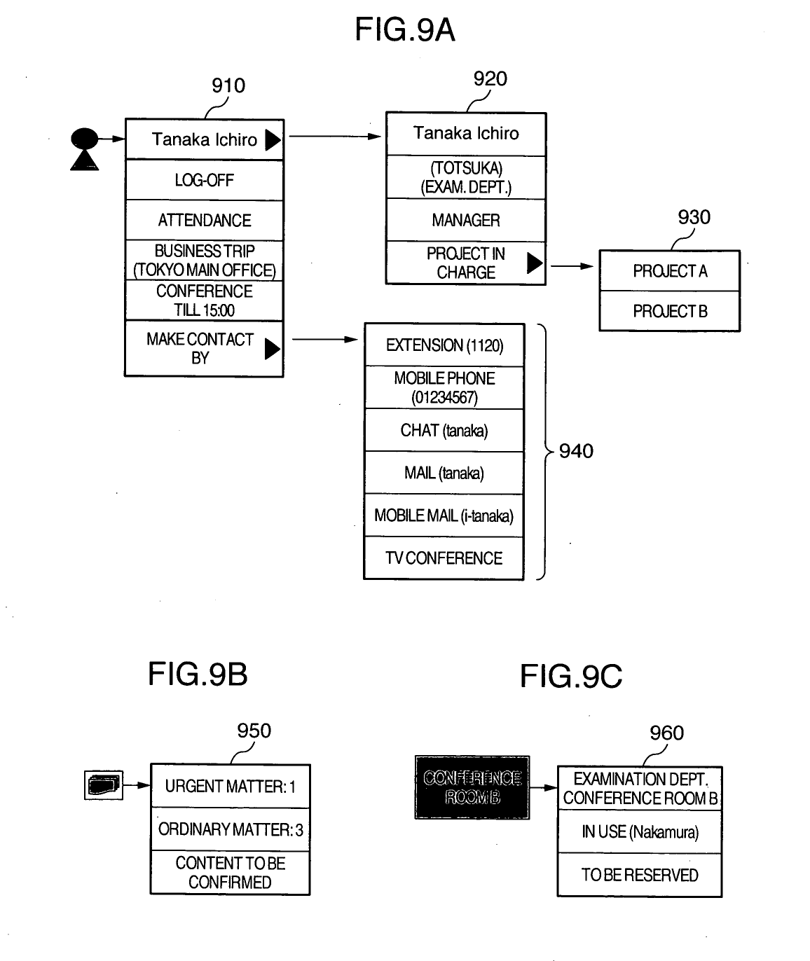

FIGS. 9A, 9B, 9C show user terminal screens for displaying the detail of the presence information by a popup form.

When the user icon shown in FIG. 7 or 8 is clicked by the mouse, the user name (“Tanaka Ichiro”), the detail item of the presence (“log-off”, “attendance”, “business trip (Tokyo Main Office)”, “conference till 15:00”, etc) are displayed by the popup menu 910, and the basic attribute 920 of the user (“Tanaka Ichiro”, “(Totsuka), (Exam. Dept.)”, “(Manager)”, etc) and a list of projects in charge 930 (“project A”, “project B”) and a list of communication means 940 (“extension number. (1120)”, “mobile phone number (01234567)”, “chat (tanaka)”, “mail (tanaka)”, “TV conference”, etc) are displayed. A script can be set to the list of the projects in charge so as to activate the presence display screen of the specific project. A script can be set to the list of the communication means for directly activating the respective application.

Referring to FIG. 9B, when the tray icon shown in FIG. 7 is clicked by the mouse, the document presence (“urgent document: 1”, “ordinary documents: 3”, etc) is displayed by the popup menu 950, and a script for activating an application for confirming the document content can be set (connected to the sales task management server).

Referring to FIG. 9C, when the conference room icon shown in FIG. 7 is clicked by the mouse, the conference room name and the presence (“examination department conference room”, “in-use” (nakamura)”, etc) is displayed by the popup menu 960 and a script for activating an application for reserving the conference room can be set.

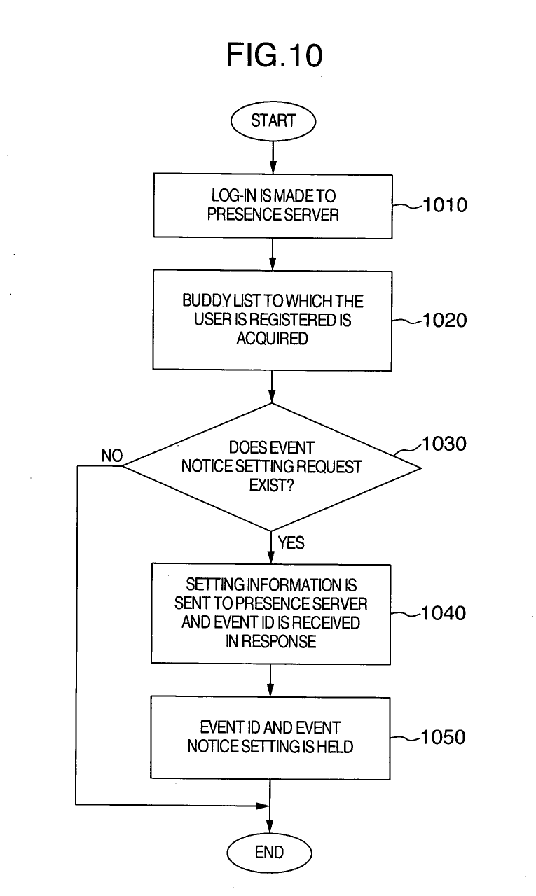

FIG. 10 is a flowchart of the initialization/event notice setting functional unit 310. The process shown in FIG. 10 is executed when the CPU 201 executes the program of the initialization/event notice setting functional unit.

To begin with, log-in is made by sending the user ID and the password to the presence server 150 (Step 1010) and a buddy list to which this user is registered is acquired (Step 1020).

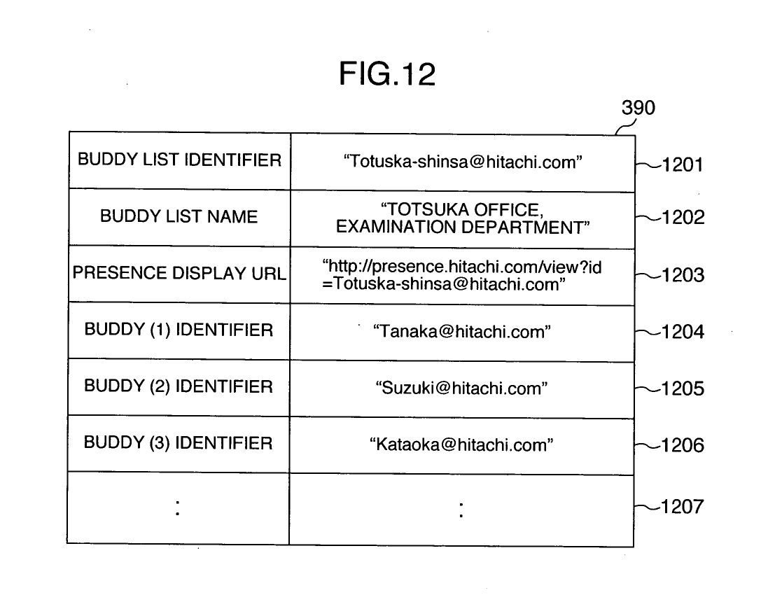

FIG. 12 shows an example of the buddy list information. The buddy list information 390 includes a buddy list identifier (Totsuka-shinsa@hitachi.com) 1201, a buddy list name (“Totsuka office, examination department”) 1202, a presence display URL (http://prsence.hitachi.com/view?id=Totsuka-shinsa@hitachi.com), a first buddy identifier (Tanaka@hitachi.com), a second buddy identifier (Suzuki@hitachi.com), a third buddy identifier (Kataoka@hitachi.com), followed then by the repetition by the number of bodies.

Turning back to FIG. 10, when the event notice setting request is raised from the user (Step 1030), the setting information is sent to the presence server 150 and the event identifier is received in response (Step 1040). The process is completed by holding the event identifier and the event notice setting (Step 1050).

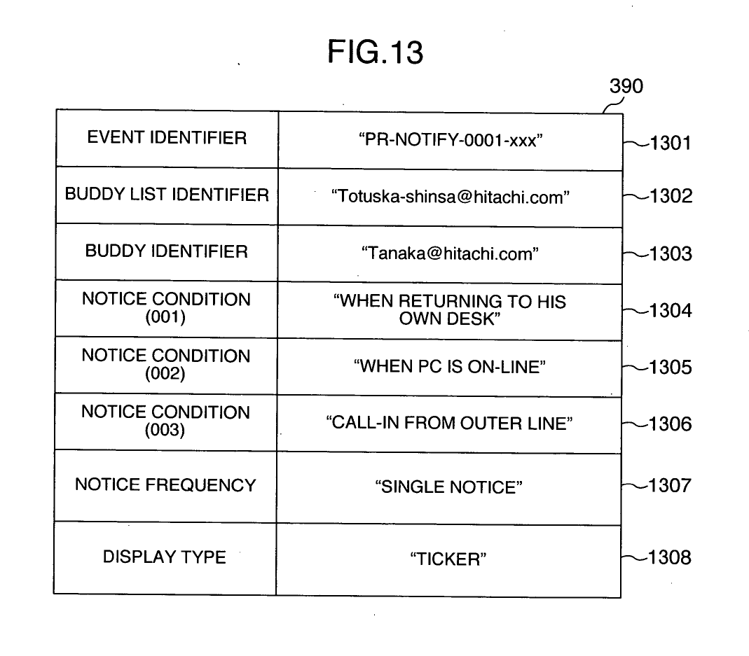

FIG. 13 shows an example of the event notify setting information. The setting information 390 includes an event identifier (“PR-NITIFY-0001-xxx” 1301, a buddy list identifier (Totsuka-shinsa@hitachi.com) 1302, a buddy identifier (Tanaka@hitachi.com) 1303, a first notice condition (“when returning to his own seat”) 1304, a second notice condition (“when PC on-line”) 1305, a third notice condition (“call-in from extension”) 1306, followed then by the repetition of conditions, a notice frequency (“single notice”) 1307 and a display type (“ticker”) 1308.

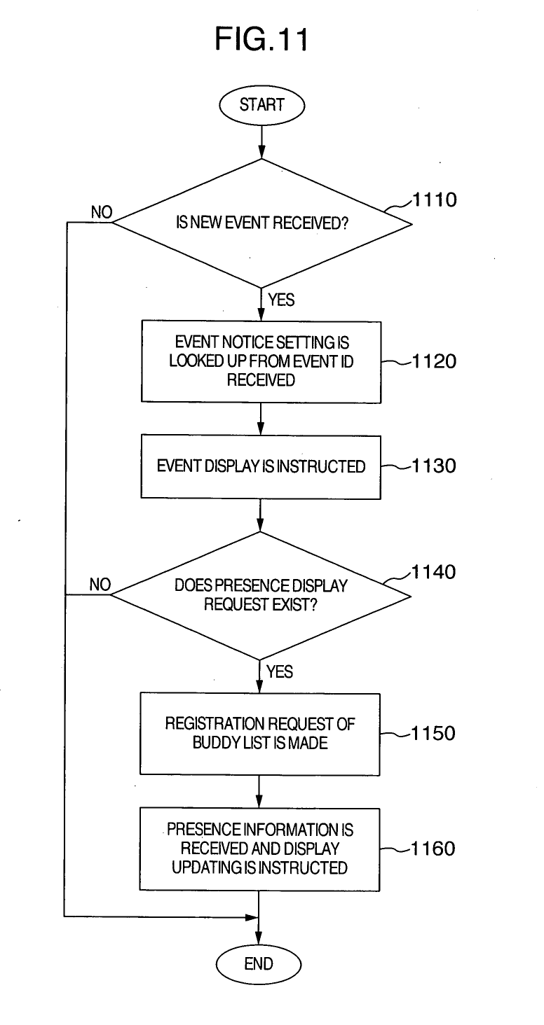

FIG. 11 is a flowchart of a dynamic buddy list management functional unit 340. The process shown in FIG. 11 is carried out when the CPU 201 executes a program of a dynamic buddy list 340.

First of all, when a novel event is received from the presence server 150 (Step 1110), the event notice setting information is looked up from the event identifier received (Step 1120) and event display is instructed to an interface control unit (Step 1130). Next, when the presence display request is made from the user (Step 1140), a subscribe registration request of the buddy list is made to the presence server 150 (Step 1150), the updated presence information is received from the presence server 150 and display updating is instructed to the interface control functional unit (1160).

According to the invention, the presence display of the buddy list can be easily switched in match with the condition change of the buddy or the document even when the buddy executes a plurality of works or businesses in parallel. The invention makes it possible also to get into contact with the buddy by taking the presence into consideration or to make smooth communication by looking up the document and eventually to reduce the burden of the user operation and the system.

The invention can thus provide a group communication assistance system capable of correctly confirming the conditions of the bodies, etc, even when the presence of the bodies changes in a complicated way.

It should be further understood by those skilled in the art that although the foregoing description has been made on embodiments of the invention, the invention is not limited thereto and various changes and modifications may be made without departing from the spirit of the invention and the scope of the appended claims.

1. An assistance system connected to a presence server, comprising:
an event notice setting functional unit for conducting prior setting for notifying a change of presence of a buddy to said presence server;
a dynamic buddy list management functional unit for acquiring presence information of a buddy list to which said buddy belongs by taking the event notified from said presence server as an opportunity, and displaying said presence information on a display screen in a form suitable for said buddy list; and
an interface control functional unit for controlling a user interface.

2. An assistance system according to claim 1, wherein said event notice setting functional unit urges a user to select predetermined information as a condition for notifying the event from said presence server to said assistance system.

3. An assistance system according to claim 2, wherein said predetermined information contains any of a specific buddy list, a specific user, updating of the presence to be notified, a notice frequency and a display form of a notified event.

4. An assistance system according to claim 1, wherein said dynamic buddy list management functional unit displays the presence of the buddy list associated with said event on the display screen.

5. An assistance system according to claim 1, wherein said interface control functional unit executes display on said display screen by either a floor view form that visually displays the presence information on a seat layout for each department of an office or a location view form that visually displays the presence information on a geographical map of project members for each project of tasks.

6. An assistance system according to claim 1, wherein said interface control functional unit displays a list of predetermined data by taking the selection of user icons on said display screen as an opportunity, and switches said display screen by taking the selection of a specific project as an opportunity.

7. An assistance system according to claim 1, wherein said interface control functional unit displays a condition of a tray of said buddy by taking the selection of a document icon on said display screen as an opportunity, activates an application and confirms project content.

8. An assistance system according to claim 1, wherein said interface control functional unit displays a use condition of a conference room when a conference room icon on said display screen is selected, activates an application and urges a user to reserve said conference room.
